(19) United States
(12) Patent Application Publication
(10) Pub. No.: US 2017/0023741 A1
(43) Pub. Date: Jan. 26, 2017

(54) WAVELENGTH-SELECTING OPTICAL SWITCH DEVICE

(71) Applicant: FURUKAWA ELECTRIC CO., LTD., Tokyo (JP)

(72) Inventor: Masaki IWAMA, Tokyo (JP)

(73) Assignee: FURUKAWA ELECTRIC CO., LTD., Tokyo (JP)

(21) Appl. No.: 15/285,868

(22) Filed: Oct. 5, 2016

Related U.S. Application Data
(63) Continuation of application No. PCT/JP2015/078289, filed on Oct. 6, 2015.

(30) Foreign Application Priority Data
Oct. 10, 2014 (JP) 2014-209233

(51) Int. Cl. G02B 6/35; G02B 6/293; G02B 6/32; G02B 6/27

(52) U.S. Cl. CPC G02B 6/3512; G02B 6/2773; G02B 6/2766; G02B 6/29311; G02B 6/32; G02B 6/3588

(57) ABSTRACT

A wavelength-selecting optical switch device includes: an optical input/output port including a plurality of ports; an optical operation element having polarization dependence characteristics and configured to output light input from any port of the optical input/output port to any port of the optical input/output port; a condenser lens system configured to optically couple the optical input/output port with the optical operation element; an optical dispersion element configured to disperse input light in a light dispersion direction; a polarization operation element configured to output two lights having a polarization state orthogonal to each other in a direction forming an angle to each other on a plane parallel to the optical switch direction; and a polarization rotation element configured to cause polarization directions of two lights output from the polarization operation element and having a polarization state orthogonal to each other to be identical to each other.

### CROSS-REFERENCE TO RELATED APPLICATION(S)

This application is a continuation of PCT International Application No. PCT/JP2015/078289 filed on Oct. 6, 2015 which claims the benefit of priority from Japanese Patent Application No. 2014-209233 filed on Oct. 10, 2014, the entire contents of which are incorporated herein by reference.

### BACKGROUND

1. Field of the Disclosure

The present disclosure relates to a wavelength-selecting optical switch device.

2. Description of the Related Art

In a recent optical communication system, the mode thereof has been developing from a point-to-point network to a ring network or a mesh network. An optical switch device that is an optical operation device for inputting or outputting an arbitrary signal light to or from an arbitrary port to change a signal light path arbitrarily is required for the node of the network in such a mode. Particularly, when a WDM signal light in which signal lights having different wavelengths from each other are wavelength-division multiplexed is to be used, a wavelength-selecting optical switch device that can change the path arbitrarily with respect to the signal light having an arbitrary wavelength is required.

In the optical switch device, there is one that uses a liquid crystal on silicon (LCOS) in order to switch the signal light path (see U.S. Pat. No. 7,397,980, U.S. Pat. No. 7,787,720, and Japanese Patent Application Laid-open No. 2012-093523). The LCOS is a type of a spatial light modulator (SLM). The SLM consists of pixels of a plurality of phase modulation elements arrayed one-dimensionally or two-dimensionally, and light can be operated by controlling the phase of the respective pixels. In the LCOS, the phase modulation elements consist of liquid crystals, and the phase of the input light can be modulated and diffracted by liquid crystals. Therefore, in an optical switch device using the LCOS, a signal light input from a certain path is diffracted (reflected) by the LCOS and is output to a particular path, thereby realizing an optical switch operation.

Because the LCOS utilizes birefringence of liquid crystals, the LCOS has polarization dependence characteristics. In order to eliminate the polarization dependence characteristics, an optical switch device using the LCOS may include a polarization separation element and a polarization rotation element. Such an optical switch device is configured such that the polarization separation element separates a signal light input to the optical switch device into two linearly polarized signal lights orthogonal to each other, and the polarization rotation element rotates a polarization direction of one of the signal lights to match the polarization direction of the signal light with a polarization direction of the other of the signal lights, thereby causing the two signal lights with the polarization directions thereof being matched with each other to enter into the LCOS. Accordingly, the signal lights in a single polarization direction are caused to enter into the LCOS, thereby solving the problem of the polarization dependence characteristics. The separated signal lights are polarization-synthesized thereafter by optical reciprocity of the polarization rotation element and the polarization separation element.

However, in the configuration disclosed in U.S. Pat. No. 7,397,980, the signal light is polarization-separated by the polarization separation element and the polarization-separated signal lights are input to a diffraction grating at different angles. Therefore, the respective polarized signal lights are affected by aberration of different degrees when the signal lights are affected by aberration such as astigmatism, comatic aberration, or wavefront aberration of the diffraction grating. Particularly, the influence of aberration and the difference thereof increases as a difference of an incident angle of each polarization to the diffraction grating increases. Such aberration causes a difference in optical coupling efficiency of the respective polarized signal lights, and may increase an insertion loss of the optical switch device. Further, when the polarization-separated signal lights pass through many optical elements, a difference in refractive power or wavefront aberration that the respective signal lights receive from the optical elements depending on the polarization state thereof accumulates. Therefore, the quality of the signal light which is polarization-synthesized thereafter may decrease as compared to the quality thereof at the time of input. The difference in the refractive power and the wavefront aberration received by the respective signal lights can be suppressed by improving the accuracy of the size and alignment of the optical elements. However, productivity of the optical switch device may decrease.

In the configuration disclosed in Japanese Patent Application Laid-open No. 2012-093523, because a polarization separation element is arranged in front of the LCOS, the problem that the polarization-separated signal lights enter into the diffraction grating at different angles does not occur. However, the optical switch device has such a characteristic that as the number of optical input/output ports increases, the spot size of the signal light at the time of being input to the LCOS increases. Therefore, in the configuration of U.S. Pat. No. 7,787,720, as is understood from FIG. 5 and the like, in order to perform polarization separation of the signal light having an increased spot size with a sufficient distance therebetween, it may be necessary to increase the length of the polarization separation element in a traveling direction and a polarization separation direction of light. Therefore, there is a problem that a footprint and the material/production cost of the optical switch device may increase.

In U.S. Pat. No. 7,787,720, the signal light is separated in a light dispersion direction. In this case, the required length of the diffraction grating, a condenser lens, and the like in the light dispersion direction increases to double or more. Therefore, the cost of respective elements and the footprint of the optical switch device increase.

There is a need for a wavelength-selecting optical switch device that can decrease a footprint, is inexpensive, and has excellent insertion loss characteristics.

### SUMMARY

It is an object of the present disclosure to at least partially solve the problems in the conventional technology.

According to one aspect of the present disclosure, there is provided a wavelength-selecting optical switch device including: an optical input/output port comprising a plurality of ports, to which light is input from outside or from which light is output to outside, the plurality of ports being arrayed in an optical switch direction; an optical operation element having polarization dependence characteristics and configured to output light input from any port of the optical input/output port to any port of the optical input/output port; a condenser lens system arranged between the optical input/output port and the optical operation element and configured to optically couple the optical input/output port with the optical operation element; an optical dispersion element arranged between the optical input/output port and the condenser lens system and configured to disperse input light in a light dispersion direction; a polarization operation element arranged between the condenser lens system and the optical dispersion element and configured to output two lights included in input light and having a polarization state orthogonal to each other in a direction forming an angle to each other on a plane parallel to the optical switch direction; and a polarization rotation element arranged between the polarization operation element and the optical operation element and configured to cause polarization directions of two lights output from the polarization operation element and having a polarization state orthogonal to each other to be identical to each other.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic configuration diagram of an optical switch device according to a first embodiment;

FIG. 2 is a schematic configuration diagram of the optical switch device according to the first embodiment;

FIGS. 3A and 3B are diagrams illustrating an example of a display image of an optical switch element illustrated in FIG. 1;

FIG. 4 is a schematic configuration diagram of an optical switch device according to a second embodiment;

FIG. 5 is a schematic configuration diagram of the optical switch device according to the second embodiment;

FIG. 6 is an explanatory diagram of an angle of a signal light in the optical switch device according to the first embodiment;

FIG. 7 is a schematic configuration diagram of an optical switch device according to a third embodiment;

FIG. 8 is an explanatory diagram of a configuration in the optical switch device according to the third embodiment;

FIG. 9 is an explanatory diagram of a configuration using a deformed Savart plate; and

FIG. 10 is an explanatory diagram of a configuration in which an optical axis of a rutile element is changed.

### DETAILED DESCRIPTION

Exemplary embodiments of a wavelength-selecting optical switch device according to the present disclosure will be explained below in detail with reference to the accompanying drawings. The present disclosure is not limited to the embodiments. In the drawings, identical constituent elements or corresponding constituent elements are denoted by like reference signs appropriately. Further, it should be noted that the drawings are schematic and a scale relation between the respective elements, a ratio of the respective elements, and the like may be different from an actual scale and an actual ratio. There is a case where some parts have a different scale relation and a ratio between the drawings. In the drawings, the direction is described by appropriately using an xyz coordinate system that is 3-axis (an x axis, a y axis, and a z axis) orthogonal coordinate system.

### First Embodiment

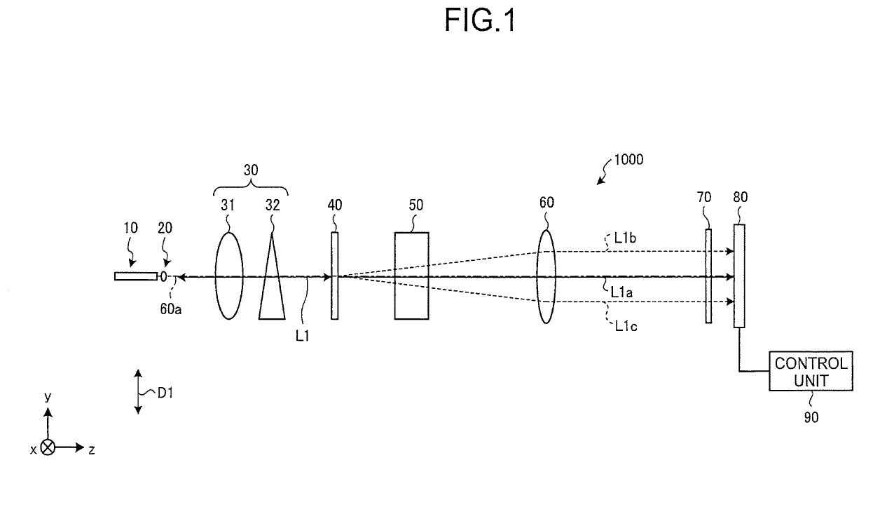

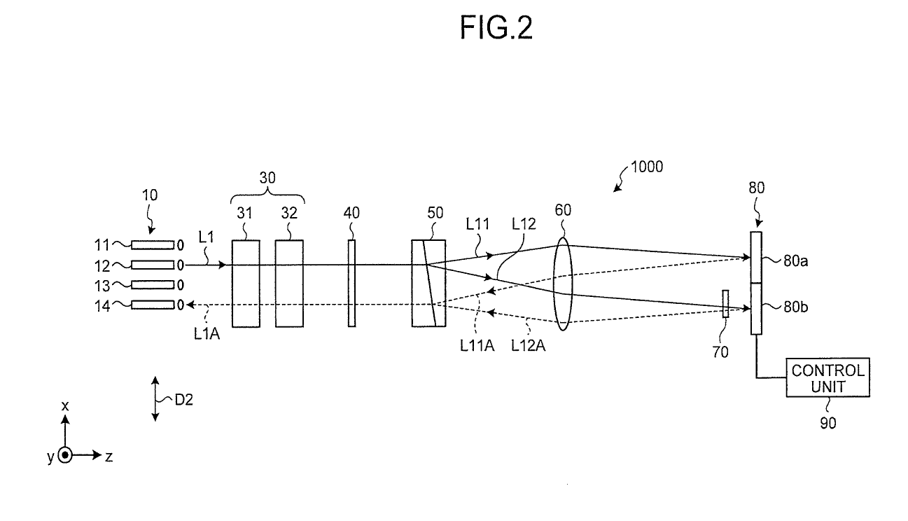

FIGS. 1 and 2 are schematic configuration diagrams of an optical switch device according to a first embodiment of the present disclosure. FIG. 1 is a diagram of an optical switch device 1000 as viewed from a negative side of the x axis. FIG. 2 is a diagram of the optical switch device 1000 as viewed from a positive side of the y axis.

The optical switch device 1000 is configured by arranging an optical input/output port 10, a collimator lens array 20, an anamorphic optical system 30, a diffraction grating 40 that is a light dispersion element, a Wollaston prism 50 that is a polarization operation device, a condenser lens 60 that is a condenser lens system, a half wavelength plate 70 that is a polarization rotation element, and an optical switch element 80 that is an optical operation element in this order. The optical switch device 1000 includes a control unit 90 that controls the optical switch element 80.

In practice, an optical path is bent in the diffraction grating 40. Therefore, the respective elements from the anamorphic optical system 30 to the optical switch element 80 are arranged with an angle on the front and back of the diffraction grating 40. The optical path may be shifted to a y-axis direction in the anamorphic optical system 30. However, in FIGS. 1 and 2, the respective elements are arranged in series along an optical axis 60a of the condenser lens 60 that is parallel to a z-axis direction for simplifying descriptions.

The optical input/output port 10 includes a plurality of optical fiber ports 11, 12, 13, and 14 formed of optical fibers. The optical fiber ports 11 to 14 are arrayed in array substantially at a regular interval along a predetermined array direction (a direction D2, which is an optical switch direction along the x axis). Light is input from outside to the optical fiber ports 11 to 14, and light is output from the optical fiber ports 11 to 14 to outside. In the present specification, a configuration in which the optical fiber ports are arrayed in array along the direction D2 is described. However, the present disclosure can be also applied to a two-dimensional array optical fiber ports in which the optical fiber ports are also arrayed in a direction D1. The light to be input in or output from the optical switch device 1000 is not particularly limited; however, it is, for example, a signal light for optical communication having a wavelength of 1520 to 1620 nanometers.

The collimator lens array 20 includes a plurality of collimator lenses. The respective collimator lenses constituting the collimator lens array 20 are provided corresponding to the respective optical fiber ports 11 to 14 constituting the optical input/output port 10. The collimator lens array 20 has a function of changing light output from the respective optical fiber ports 11 to 14 to collimated light or focusing the input collimated light to the respective optical fiber ports 11 to 14 and coupling the light.

The optical switch element 80 is an SLM, for example. In the first embodiment, it is assumed that the optical switch element 80 is a type of the SLM, and is the LCOS in which pixels of liquid crystals, which are phase modulation elements, are two-dimensionally arrayed.

The optical switch element 80 has a function of reflecting (diffracting) light input from any one of the optical fiber ports in the optical input/output port 10 to switch the optical path, and outputting the light toward any other one of the optical fiber ports in the optical input/output port 10. As illustrated in FIG. 2, the optical switch element 80 includes two regions 80a and 80b arranged in the direction D2.

The condenser lens 60 is a point symmetric lens whose curvatures in the x-axis and y-axis directions are the same, and is arranged between the optical input/output port 10 and the optical switch element 80. The condenser lens 60 optically couples the optical input/output port 10 with the optical switch element 80.

The diffraction grating 40 is a transmission diffraction grating, and disperses the light input from any of the optical fiber ports in the optical input/output port 10 in a light dispersion direction (the direction D1 along the y axis). The diffraction grating 40 and the optical switch element 80 are respectively arranged substantially at a focal position on the front and rear sides of the condenser lens 60. The focal position is assumed here as a position away from the lens or from a principal surface of the lens system by a focal length.

The Wollaston prism 50 is arranged between the condenser lens 60 and the diffraction grating 40. The Wollaston prism 50 can output two lights having a polarization state orthogonal to each other, which are included in the light input from the side of the optical input/output port 10, by bending the optical path in a direction forming an angle in a direction opposite to each other with respect to the incident direction of the input light. In the first embodiment, the Wollaston prism 50 is arranged so that the two lights are output in a direction forming an angle in the direction opposite to each other on a plane parallel to the direction D2 (an xz plane). Further, the Wollaston prism 50 has the optical reciprocity. Accordingly, the Wollaston prism 50 has a function of coupling and outputting two lights having the polarization state orthogonal to each other, which are input from the side of the condenser lens 60 in the optical path forming an angle in the direction opposite to each other.

The anamorphic optical system 30 is arranged between the optical input/output port 10 and the diffraction grating 40. The anamorphic optical system 30 is configured by arraying in series a cylindrical lens 31 having refractive power only in the direction D1 and an anamorphic prism 32 having diffractive power only in the direction D1. The anamorphic optical system 30 has a function of enlarging a beam shape of the light input from the side of the optical input/output port 10 in the direction D1. Because the anamorphic optical system 30 has the optical reciprocity, the anamorphic optical system 30 has a function of decreasing the beam shape of the light input from the side of the optical switch element 80 in the direction D1. The anamorphic optical system 30 can be replaced by another anamorphic optical system using, for example, one or two anamorphic prisms.

The half wavelength plate 70 is arranged between the Wollaston prism 50 and the optical switch element 80. However, in the first embodiment, the half wavelength plate 70 is arranged on the side of the condenser lens 60 of the optical switch element 80. As described later, the half wavelength plate 70 is arranged on an optical path of one of the polarized lights separated by the Wollaston prism 50. The half wavelength plate 70 is arranged so that an angle formed between a slow axis and a polarization axis becomes 45 degrees with respect to linear polarization of the one of the polarized lights.

The control unit 90 applies a voltage signal to the pixels of the respective phase modulation elements of the optical switch element 80, to control the phase of the light provided by the pixel. The control unit 90 includes, for example, a voltage-signal generating unit, a computing unit, and a storage unit. The voltage-signal generating unit generates a voltage signal to be applied to the optical switch element 80. The computing unit performs various types of arithmetic processing for controlling the voltage-signal generating unit, and is formed of a central processing unit (CPU), for example. The storage unit includes a part formed of, for example, a ROM (Read Only Memory) in which various programs and data that the computing unit uses for performing the arithmetic processing are stored, and a part formed of, for example, a random access memory (RAM) that is used as a work space when the computing unit performs the arithmetic processing and for storing results or the like of the arithmetic processing performed by the computing unit. Further, the control unit 90 can control the regions 80a and 80b independently.

In the optical switch device 1000, any one of the optical fiber ports 11 to 14 functions as a common optical fiber port (Com port) to which light is input from outside, and the other three optical fiber ports are set as optical fiber ports for outputting light to outside. That is, the optical switch device 1000 functions as a 1×3 optical switch.

An operation of the optical switch device 1000 is described with reference to FIGS. 1 and 2, for a case where the optical fiber port 12 is set as the Com port.

First, a signal light L1 is input to the optical fiber port 12 from outside. The signal light L1 is assumed to be a WDM signal light and include signal lights L1a, L1b, and L1c having different wavelengths from each other. Regarding the wavelengths of the signal lights L1a, L1b, and L1c, it is assumed that the signal light L1c has the longest wavelength, the signal light L1b has the shortest wavelength, and signal light L1a has an intermediate wavelength therebetween.

The optical fiber port 12 outputs the input signal light L1 to a corresponding collimator lens of the collimator lens array 20. The collimator lens transforms the signal light L1 to substantially collimated light having a substantially circular beam shape.

The anamorphic optical system 30 enlarges the beam shape of the signal light L1 output from the collimator lens in the direction D1 to ovalize the beam shape.

The diffraction grating 40 diffracts the ovalized signal light L1 at a predetermined diffraction angle corresponding to the wavelength. As a result, as illustrated in FIG. 1, the signal light L1 is dispersed to the signal lights L1a, L1b, and L1c, respectively. In FIG. 2, the dispersed signal lights are illustrated as the signal light L1 for simplifying the drawing.

The Wollaston prism 50 separates the signal light L1 input from the side of the anamorphic optical system 30 into two signal lights L11 and L12 having the polarization state orthogonal to each other, which are included in the signal light L1 (L1a, L1b, L1c), bends the optical path thereof so as to form an angle opposite to each other with respect to the incident direction of the signal light L1 on the xz plane, and outputs the signal lights L11 and L12. In the first embodiment, the signal light L11 has polarization in the y-axis direction and the signal light L12 has polarization in the x-axis direction. There are two signal lights separated from each of the signal lights L1a, L1b, and L1c. However, for simplifying the drawing, only the signal lights L1a, L1b, and L1c in one polarization direction are illustrated. In FIG. 2, the separated polarized signal lights are represented by the signal lights L11 and L12 and illustrated. In this manner, in the present specification, when the signal lights having a different wavelength are mainly described, the reference signs L1a, L1b, and L1c may be used, and when the signal lights having a different polarization state are described, the reference signs L11 and L12 may be used.

The condenser lens 60 focuses the diffracted signal lights L1a, L1b, and L1c to different areas of the optical switch element 80. As described above, the optical switch element 80 is arranged substantially at a focal position of the condenser lens 60. Therefore, the signal lights L1a, L1b, and L1c (L11, L12) are substantially focused on the optical switch element 80. As illustrated in FIG. 2, with regard to the signal light L12, the polarization direction thereof is rotated by 90 degrees by the half wavelength plate 70 arranged on the optical path thereof and the signal light L12 enters into the optical switch element 80. As a result, the signal lights L11 and L12 enter into the optical switch element 80, in a state with the polarization directions thereof being in the y-axis direction. Thus, the half wavelength plate 70 makes the polarization directions of the signal lights L11 and L12 the same. The optical switch element 80 has polarization dependence on the phase change amount thereof. However, in the first embodiment, because the optical switch element 80 is arranged so as to be able to control the phase change amount with respect to the light in the y-axis polarization direction, a difference in the diffraction efficiency due to a difference in the polarization state between the signal lights L11 and L12 is eliminated. Further, the signal lights L11 and L12 enter into the surface of the optical switch element 80 at different angles from each other.

In the optical switch element 80, an input region is formed in a region on which the respective polarized signal lights (signal lights L11 and L12) of the signal lights L1a, L1b, and L1c are focused. The input regions of the signal lights L1a, L1b, and L1c are arranged in the direction D1, which is a chromatic dispersion direction. Further, the input regions of the signal lights L11 and L12 are the regions 80a and 80b described above and are arranged in the direction D2, which is the optical switch direction. In the input regions, the phase of a plurality of pixels included in the input region is controlled by the control unit 90, so that the respective signal lights L1a, L1b, and L1c are reflected (diffracted) at a predetermined angle corresponding to the wavelength of the respective signal lights.

The regions on which the signal lights L11 and L12 are focused are respectively the regions 80a and 80b. However, the incident angle of the signal light L11 to the region 80a and the incident angle of the signal light L12 to the region 80b are different from each other. Therefore, in the regions 80a and 80b, the control unit 90 controls the phase so as to reflect the signal lights L11 and L12 at different reflection angles, so that the signal lights L11 and L12 are synthesized again later by the Wollaston prism 50.

The reflected light of the signal light L1a is described here on behalf of the reflected signal lights as signal lights L11A and L12A. The polarization direction of the signal light L12A is rotated again by 90 degrees by the half wavelength plate 70. Thereafter, the signal lights L11A and L12A pass through the condenser lens 60 and are affected by refraction opposite to refraction before being reflected due to the optical reciprocity.

The Wollaston prism 50 couples the signal lights L11A and L12A having the polarization state orthogonal to each other by the optical reciprocity, to return the signal lights L11A and L12A to the signal light L1A. The signal light L1A passes through the diffraction grating 40 and undergoes diffraction opposite to the diffraction before being reflected by the optical reciprocity. The anamorphic optical system 30 decreases the beam shape of the signal light L1A in the direction D1 by the optical reciprocity and returns the beam shape to its original shape that is a substantially circular shape. Thereafter, the signal light L1A is input to the collimator lens corresponding to the optical fiber port 14. The collimator lens focuses the signal light L1A and couples the signal light L1A to the optical fiber port 14. The optical fiber port 14 outputs the coupled signal light L1A to outside. As described above, the optical switch device 1000 can switch the path of the signal light L1a included in the signal light L1 input from the optical fiber port 12 being the Com port, to the optical fiber port 14.

Furthermore, with regard to the signal lights L1b and L1c having other wavelengths included in the signal light L1, each path thereof is switched to the optical fiber port other than the optical fiber port 14, that is, the optical fiber ports 11 and 13 in the same manner. Accordingly, switching of a desired path for each wavelength of the signal light can be realized.

In the optical switch device 1000, the signal light L1 passes through the diffraction grating 40 and is polarization-separated by the Wollaston prism 50. Therefore, the two polarized signal lights L11 and L12 orthogonal to each other that are included in the signal light L1 are input to the diffraction grating 40 at the same angle before being separated. Therefore, the influence of aberration caused by the diffraction grating 40 becomes the same as that in the signal lights L11 and L12. Further, the number of optical elements, through which the separated signal lights L11 and L12 pass, also decreases. As a result, in the optical switch device 1000, an increase of insertion loss and a decrease of the productivity can be suppressed, and the optical switch device 1000 becomes an optical switch device having excellent insertion loss characteristics and productivity. By constituting the condenser lens 60 by an aspheric lens having less aberration or by using a condenser lens system having less aberration such as a condenser lens system constituted by, for example, two plano-convex lenses arranged opposite to each other instead of the condenser lens 60, an optical switch device having further excellent insertion loss characteristics and productivity can be configured.

In the optical switch device 1000, the Wollaston prism 50 is provided in front of the condenser lens 60 to output the signal lights L11 and L12 in directions forming an angle therebetween. Therefore, even if the optical input/output port 10 includes multiple ports and the spot size of the signal lights L11 and L12 at the time of being input to the optical switch element 80 increases, an increase in the size of the Wollaston prism 50 can be suppressed. It is because the polarization separation distance of the present optical system is decided by an angle formed by birefringent crystals constituting the Wollaston prism and a birefringence index, and does not depend on the size. On the other hand, the polarization separation distance of the birefringent crystals as described in Japanese Patent Application Laid-open No. 2012-093523 depends on a crystal length in a propagation direction of light. Therefore, the optical switch device 1000 can suppress an increase of the footprint and the material/production cost, and thus the footprint can be reduced, thereby realizing an inexpensive optical switch device.

The spot size of the signal lights L11 and L12 in the x-axis direction at the time of being input to the optical switch element 80 is inversely proportional to the spot size of the signal light L1 at the time of being input from the optical fiber port 12. When the optical input/output port 10 is configured to include multi ports, in order to suppress that the optical switch device grows in size due to the multi-port optical input/output port 10, it is desired that the optical fiber port has the spot size of 60 micrometers or less at a beam waist of the signal light immediately after the collimator lens, or an array pitch of 250 micrometers or less. If the array pitch of the optical fiber port is decreased, the spot size of the signal light also decreases. In the case of the small spot size of the signal light L1, the spot sizes of the signal lights L11 and L12 when being input to the optical switch element 80 increase. However, according to the configuration of the optical switch device 1000, an increase of the foot print with an increase of the spot size can be suppressed.

Furthermore, in the optical switch device 1000, because the signal lights L11 and L12 are separated in the optical switch direction, an increase in the required length of the optical switch element 80 in the light dispersion direction can be suppressed. Accordingly, the optical switch device 1000 becomes an optical switch device that can decrease the footprint. Further, in the optical switch device 1000, because the signal lights L11 and L12 are separated in terms of angle, the regions on which the signal lights L11 and L12 are focused in the optical switch element 80 can be easily set as separate regions 80a and 80b. Therefore, a simple configuration in which only the condenser lens 60 is provided can be realized as a lens having refractive power in the optical switch direction. On the other hand, if the signal lights L11 and L12 are not separated in terms of angle in front of the condenser lens, in order to separate the regions on which the signal lights L11 and L12 are focused in the optical switch element 80, it is necessary to provide another lens having the refractive power in the optical switch direction.

In the optical switch device 1000, because the anamorphic optical system 30 enlarges the beam shape of the signal light L1 in the y-axis direction, the position of the beam waist of the signal light L1 in the z-axis direction is different from that in the x-axis direction and the y-axis direction. Specifically, the position of the beam waist in the x-axis direction becomes further away from the condenser lens 60 than the position of the beam waist in the y-axis direction. In this case, if the optical switch element 80 is arranged at the position of the beam waist in the y-axis direction, the optical switch element 80 is arranged at a position closer to the condenser lens 60 than the position of the beam waist in the x-axis direction. As a result, in the x-axis direction, the beam waist of the signal light L1A from the optical switch element 80 is located closer to the side of the anamorphic optical system 30 than the end surface of the optical fiber port 14. Therefore, the signal light L1A has a decreased coupling efficiency with respect to the optical fiber port 14 and is affected by an optical loss.

In this case, it is desired to locate the beam waist of the signal light L1A on the end surface of the optical fiber port 14 in both the x-axis direction and the y-axis direction, by arranging the optical switch element 80 at the position of the beam waist of the signal light L1 in the y-axis direction and executing control by the control unit 90 so that the optical switch element 80 functions as a reflective Fresnel lens in the x-axis direction. Accordingly, a decrease of the coupling efficiency of the signal light L1A with respect to the optical fiber port 14 can be suppressed.

The control unit 90 can control the optical switch element 80 so that a liquid crystal layer has a desired profile of the refractive index two-dimensionally. By adjusting the profile of the refractive index, it can be formed that the incident light undergoes phase modulation in the form of Fresnel lens when being reflected by a pixel electrode group to propagate in the liquid crystal layer. In the pseudo reflective Fresnel lens by the optical switch element 80, a curvature and a focal length as the Fresnel lens can be set to desired values by the control unit 90.

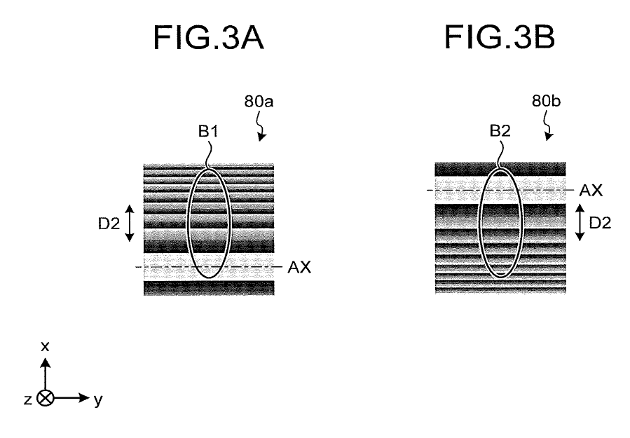

FIG. 3 are diagrams illustrating an example of a display image of the optical switch element 80. In FIGS. 3A and 3B, it is supposed that control is executed so that the optical switch element 80 works as a convex mirror. However, the optical switch element 80 can be controlled to work as a concave mirror. FIG. 3A and FIG. 3B illustrate display images in the regions 80a and 80b, respectively.

In FIGS. 3A and 3B, the refractive index in a dark-colored part is high, and the refractive index in a light-colored part is low. That is, in the region 80a, the refractive index of respective pixels is controlled so that a period of phase modulation gradually becomes short along the positive direction of the x axis. As a result, the curvature as the Fresnel lens can be worked so as to gradually increase along the positive direction of the x axis. On the other hand, in the region 80b, the refractive index of respective pixels is controlled so that the period of phase modulation gradually becomes short along the negative direction of the x axis. As a result, the curvature as the Fresnel lens can be worked so as to gradually increase along the negative direction of the x axis.

As described above, the incident angle of the signal light L11 to the region 80a and the incident angle of the signal light L12 to the region 80b are different from each other. Therefore, in the regions 80a and 80b, the control unit 90 controls the phase to reflect the signal lights L11 and L12 at different reflection angles so that the signal lights L11 and L12 are synthesized later again by the Wollaston prism 50. In the example illustrated in FIG. 3A, by shifting an optical axis AX of the Fresnel lens in the negative direction of the x axis with respect to the center of a beam B1 of the incident signal light L11 in the region 80a, the signal light L11 can be reflected in a direction forming an angle in the positive direction of the x axis. Further, in the example illustrated in FIG. 3B, by shifting the optical axis AX of the Fresnel lens in the positive direction of the x axis with respect to the center of a beam B2 of the incident signal light L12 in the region 80b, the signal light L12 can be reflected in a direction forming an angle in the negative direction of the x axis.

In this manner, by adjusting the optical axis, the curvature, and the focal length of the Fresnel lens to be formed in the region 80a and the region 80b, the signal lights L11 and L12 can be reflected as the signal lights L11A and L12A with an appropriate reflection angle so that the signal lights L11 and L12 are reliably coupled to the optical fiber port 14, and a decrease of the coupling efficiency of the signal light L1A with respect to the optical fiber port 14 can be suppressed.

In the optical switch device 1000, the number of optical elements is decreased, through which the polarization-separated signal lights L11 and L12 pass. The condenser lens 60, the half wavelength plate 70, and the like, which are optical elements through which the signal lights L11 and L12 pass after separation, may have a polarization dependent loss (PDL). For example, in a switching axis direction, a polarization pair having different incident positions to the condenser lens 60 receives slightly different refractive power. Further, if the half wavelength plate 70 is shifted in the switching axis direction, light that undergoes the action of the half wavelength plate 70 may be kicked to cause an excessive loss. In this case, for example, if the signal light L11 has a smaller optical loss due to the PDL than that of the signal light L12, the PDL can be decreased by controlling the region 80a of the optical switch element 80 so as to attenuate the signal light L11 by the control unit 90. At this time, it is desired to adjust an attenuation amount of the signal light L11 so as to be able to completely eliminate the PDL. As a method for attenuating the signal light L11, there is a method of decreasing the coupling efficiency of the signal light L11 with respect to the optical fiber port 14 by adjusting a reflection angle of the signal light L11 by the region 80a or adjusting the focal length (the curvature) of the signal light L11 when the Fresnel lens is to be drawn. Further, by performing drawing with low characteristics of the reflectivity and the diffraction efficiency with respect to the region 80a, the signal light L11 can be attenuated.

### Second Embodiment

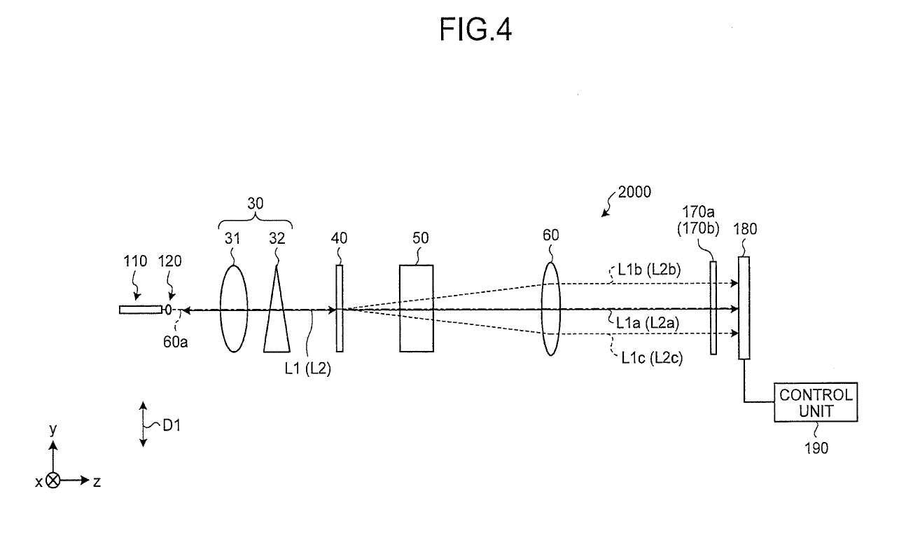

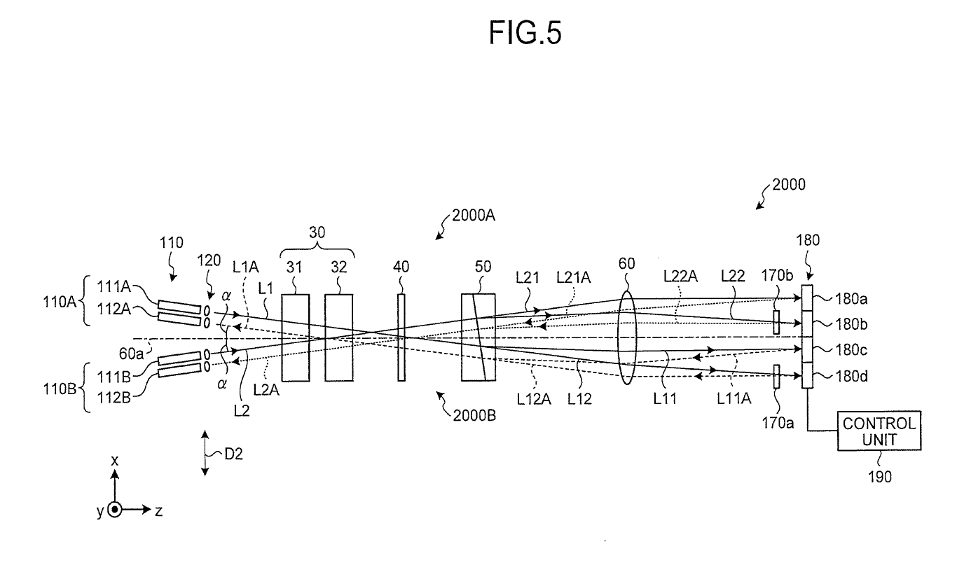

FIGS. 4 and 5 are schematic configuration diagrams of an optical switch device according to a second embodiment of the present disclosure. FIG. 4 is a diagram of an optical switch device 2000 as viewed from the negative side of the x axis. FIG. 5 is a diagram of the optical switch device 2000 as viewed from the positive side of the y axis.

As illustrated in FIGS. 4 and 5, the optical switch device 2000 has a configuration in which the optical input/output port 10, the collimator lens array 20, the half wavelength plate 70, the optical switch element 80, and the control unit 90 in the optical switch device 1000 are respectively replaced by an optical input/output port 110, a collimator lens array 120, half wavelength plates 170a and 170b, an optical switch element 180, and a control unit 190.

The optical switch device 2000 functions as a so-called N-in-1 optical switch device configured to include a plurality of (two in the second embodiment) unit optical switch devices that function in the same manner as the optical switch device 1000.

The optical input/output port 110 includes a plurality of port groups 110A and 110B provided with a plurality of optical fiber ports formed of optical fibers arrayed in a predetermined array direction (the direction D2). The port groups 110A and 110B respectively include four optical fiber ports as the optical input/output port 10. However, in FIG. 5, only two of the four optical fiber ports, that is, optical fiber ports 111A and 112A, and 111B and 112B are respectively illustrated. The port groups 110A and 110B are configured so that input/output directions of light of the optical fiber ports included in the same port group are parallel to each other, and the input/output directions of light of the optical fiber ports included in the different port groups are different from each other. Specifically, the input/output directions of light of the optical fiber ports 111A and 112A included in the port group 110A are parallel to each other. The input/output directions of light of the optical fiber ports 111B and 112B included in the port group 110B are parallel to each other. The input/output directions of light of the optical fiber ports 111A and 111B respectively included in the port groups 110A and 110B are different from each other. The port groups 110A and 110B are arranged symmetrically to each other so that the input/output directions of light form a predetermined angle α with respect to the optical axis of the condenser lens 60.

The collimator lens array 120 includes a plurality of collimator lenses, and the collimator lenses are provided corresponding to the respective optical fiber ports constituting the optical input/output port 110.

The optical switch element 180 is an LCOS, and has a function of reflecting (diffracting) light input from any of optical fiber ports of the port group 110A of the optical input/output port 110 to switch the optical path, and outputting the light toward any one of the other optical fiber ports of the port group 110A. The optical switch element 180 also has a function of reflecting (diffracting) light input from any one of optical fiber ports of the port group 110B to switch the optical path, and outputting the light toward any other one of the optical fiber ports of the port group 110B. As illustrated in FIG. 5, the optical switch element 180 includes four regions 180a, 180b, 180c, and 180d arranged in the direction D2.

The half wavelength plates 170a and 170b are respectively arranged on an optical path of one of the polarized lights separated by the Wollaston prism 50. The half wavelength plates 170a and 170b are arranged so that an angle formed between the slow axis and the polarization axis becomes 45 degrees with respect to linear polarization of the one of the polarized lights.

The control unit 190 has the same configuration as that of the control unit 90, and can independently control the regions 180a, 180b, 180c, and 180d.

The optical switch device 2000 functions in the same manner as the optical switch device 1000, and is configured to include two unit optical switch devices 2000A and 2000B having the same effects. The unit optical switch device 2000A is configured to include the port group 110A, a collimator lens corresponding to the port group 110A of the collimator lens array 120, the anamorphic optical system 30, the diffraction grating 40, the Wollaston prism 50, the condenser lens 60, the half wavelength plate 170a, the regions 180c and 180d of the optical switch element 180, and the control unit 190. Meanwhile, the unit optical switch device 2000B is configured to include the port group 110B, a collimator lens corresponding to the port group 110B of the collimator lens array 120, the anamorphic optical system 30, the diffraction grating 40, the Wollaston prism 50, the condenser lens 60, the half wavelength plate 170b, the regions 180a and 180b of the optical switch element 180, and the control unit 190.

In this manner, the optical switch device 2000 is a 2-in-1 optical switch device including the two unit optical switch devices 2000A and 2000B having a configuration in which the collimator lens array 120, the anamorphic optical system 30, the diffraction grating 40, the Wollaston prism 50, the condenser lens 60, and the control unit 190 are commonly used.

Accordingly, for example, as illustrated in FIG. 5, in the optical switch device 2000, the signal light L1 including signal lights L1a, L1b, and L1c having different wavelengths from each other, which is input from the optical fiber port 111A of the port group 110A, is changed to collimated light by the collimator lens array 120. The beam shape thereof is ovalized by the anamorphic optical system 30, and the signal light L1 is dispersed to the signal lights L1a, L1b, and L1c by the diffraction grating 40. Further, the signal lights L1a, L1b, and L1c are respectively separated into two signal lights (signal lights L11 and L12) having the polarization state orthogonal to each other by the Wollaston prism 50, and focused on the regions 180c and 180d of the optical switch element 180 by the condenser lens 60. At this time, the polarization direction of the signal light L12 is rotated by 90 degrees by the half wavelength plates 170a. The signal lights L11 and L12, which are polarization-separated lights of the signal light L1a, are reflected at a predetermined angle in the regions 180c and 180d to become the signal lights L11A and L12A. Thereafter, the signal lights L11A and L12A are polarization-synthesized by the Wollaston prism 50 to become the signal light L1A, and the signal light L1A is output from the optical fiber port 112A of the port group 110A.

Similarly, the signal light L2 including signal lights L2a, L2b, and L2c having different wavelengths from each other, which is input from the optical fiber port 111B of the port group 110B, is changed to collimated light by the collimator lens array 120. The beam shape thereof is ovalized by the anamorphic optical system 30, and the signal light L2 is dispersed to the signal lights L2a, L2b, and L2c by the diffraction grating 40. Further, the signal lights L2a, L2b, and L2c are respectively separated into two signal lights (signal lights L21 and L22) having the polarization state orthogonal to each other by the Wollaston prism 50, and focused on the regions 180a and 180b of the optical switch element 180 by the condenser lens 60. At this time, the polarization direction of the signal light L22 is rotated by 90 degrees by the half wavelength plates 170b. Further, the signal lights L21 and L22, which are polarization-separated lights of the signal light L2a, are reflected at a predetermined angle in the regions 180a and 180b to become the signal lights L21A and L22A. Thereafter, the signal lights L21A and L22A are polarization-synthesized by the Wollaston prism 50 to become the signal light L2A, and the signal light L2A is output from the optical fiber port 112B of the port group 110B.

The optical switch device 2000 functions in the same manner as the optical switch device 1000, and includes the two unit optical switch devices 2000A and 2000B having the same effect. The optical switch device 2000 has excellent insertion loss characteristics and productivity as the optical switch device 1000 and can decrease a footprint and becomes an inexpensive optical switch device.

In the optical switch device 2000, because the port groups 110A and 110B are arranged so as to form the predetermined angle α with respect to the optical axis of the condenser lens 60, for example, as illustrated in FIG. 5, the incident angles of the signal lights L1 and L2 to the diffraction grating 40 are α respectively. Meanwhile, in the case of configuration in which the Wollaston prism 50 is arranged in front of the diffraction grating 40, if it is assumed that the signal light is separated by an angle β in a direction opposite to each other by the Wollaston prism 50, the incident angles of the signal lights L1 and L2 to the diffraction grating 40 become α+β at a maximum, which is not desirable because the incident angle becomes larger than that of the optical switch device 2000.

### Third Embodiment

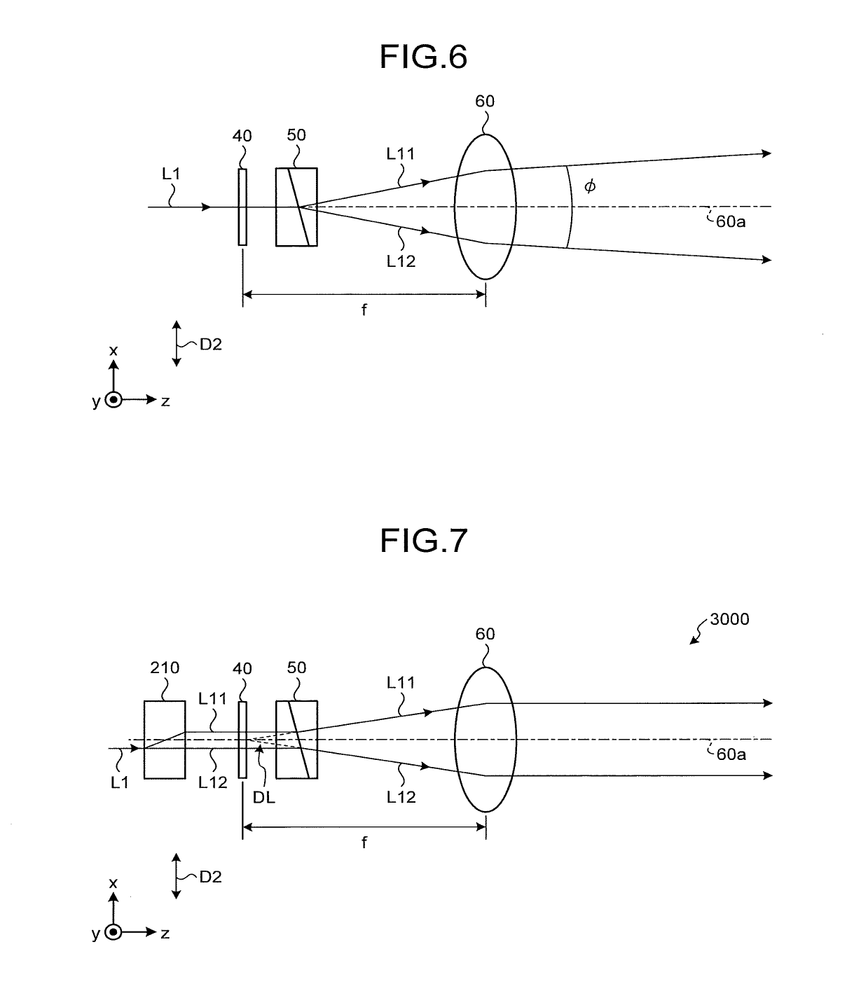

An optical switch device according to a third embodiment of the present disclosure is described next. A case where the signal light L1 is matched with the optical axis 60a of the condenser lens 60 and input from the side of the optical input/output port 10 in the optical switch device 1000 according to the first embodiment is described first with reference to FIG. 6. As described above, because the diffraction grating 40 is arranged substantially at the focal position of the condenser lens 60, the distance between the diffraction grating 40 and the condenser lens 60 is substantially equal to a focal length f of the condenser lens 60.

As described above, the Wollaston prism 50 separates the signal light L1 into the two signal lights L11 and L12 having the polarization state orthogonal to each other, and outputs the signal lights L11 and L12 by bending the optical path thereof so as to form an angle opposite to each other with respect to the incident direction of the signal light L1 on a yz plane. At this time, a starting point of separation of the signal lights L11 and L12 in terms of angle becomes a position closer to the condenser lens 60 than the focal position of the condenser lens 60. Therefore, traveling directions of the signal lights L11 and L12 having passed through the condenser lens 60 are not parallel to the optical axis 60a, and the angle formed by the signal lights L11 and L12 expands by an angle φ. In this case, the signal lights L11 and L12 do not enter into the optical switch element 80 vertically, and thus a difference in the diffraction efficiency (the reflectivity) of the optical switch element 80 may be caused between the signal lights L11 and L12, or the PDL may occur.

On the other hand, an optical switch device 3000 according to the third embodiment includes a rutile element 210 that is a polarization separation element arranged on the side of the optical input/output port 10 with respect to the Wollaston prism 50, preferably on the side of the optical input/output port 10 with respect to the diffraction grating 40 in the configuration of the optical switch device 1000 according to the first embodiment. The rutile element 210 separates the input light into two linearly polarized lights orthogonal to each other and the separated lights are output so that the respective propagation directions thereof become parallel to the propagation direction of the input light.

In the optical switch device 3000, the rutile element 210 separates the signal light L1 into the two signal lights L11 and L12, and the signal lights L11 and L12 are output in such a manner that the respective propagation directions thereof are parallel to the propagation direction of the signal light L1. Accordingly, the signal lights L11 and L12 enter into the diffraction grating 40 vertically. Subsequently, the Wollaston prism 50 outputs the signal lights L11 and L12 by bending the optical path thereof so as to form an angle in the direction opposite to each other with respect to the incident direction of the signal lights L11 and L12. In this case, because the starting point of separation of the signal lights L11 and L12 in terms of angle is shifted to the position of the diffraction grating 40 (that is, the approximate focal position of the condenser lens 60) as illustrated by a broken line DL, the traveling directions of the signal lights L11 and L12 having passed through the condenser lens 60 become parallel to the optical axis 60a. As a result, because the signal lights L11 and L12 enter into the optical switch element 80 vertically, a difference in the diffraction efficiency (reflectivity) of the optical switch element 80 and the PDL can be suppressed. The polarization separation element is not limited to the rutile element, and can be an element configured by combining, for example, calcite and a Wollaston prism in plural numbers.

In the third embodiment, the thickness of the rutile element 210 in the z axis direction is adjusted so that the starting point of separation of the signal lights L11 and L12 in terms of angle is shifted to the position of the diffraction grating 40 as illustrated by the broken line DL in FIG. 7, to set a separation distance between the signal lights L11 and L12. However, even if the starting point of separation of the signal lights L11 and L12 in terms of angle is not shifted to the position of the diffraction grating 40, if the starting point of separation is approximated from the position of the starting point illustrated in FIG. 6 toward the side of the diffraction grating 40, a divergence angle φ of the signal light L11 and L12 can be decreased, which is preferable.

The Wollaston prism is used with the optical axis thereof being arranged vertically to the incident angle of light. However, in the Wollaston prism, there is a divergence between the refractive index with respect to ordinary light and the refractive index with respect to extraordinary light. As a result, a speed difference is generated between the ordinary light and the extraordinary light, and an optical path difference is generated between the extraordinary light and the ordinary light. The optical path difference causes polarization mode dispersion (PMD) in the Wollaston prism.

In the current optical communication network, it is necessary to reduce the PMD of the wavelength-selecting optical switch device to about 0.5 picosecond. When a Wollaston prism consisting of calcite is used as the Wollaston prism of the wavelength-selecting optical switch device according to the present embodiment, the refractive index of calcite is 1.48 with respect to the extraordinary light and 1.66 with respect to the ordinary light. If it is assumed that the thickness of the Wollaston prism is 5 millimeters, an optical path difference between the ordinary light and the extraordinary light becomes about 0.85 millimeter, and the PMD that is group velocity delay (DGD) between the ordinary light and the extraordinary light reaches up to several picoseconds.

In the optical switch device 3000 according to the third embodiment, in order to compensate the PMD caused in the Wollaston prism 50, it is desired to use the characteristics of the rutile element 210. The refractive index of the rutile is 2.69 with respect to the extraordinary light, 2.44 with respect to the ordinary light, and thus the refractive index with respect to the ordinary light is lower than the refractive index with respect to the extraordinary light. That is, the rutile element 210 has a magnitude relation between the refractive index with respect to the ordinary light and the refractive index with respect to the extraordinary light, opposite to that of calcite, and has birefringence opposite to that of the Wollaston prism 50 consisting of calcite. Therefore, the PMD can be compensated by compensating an optical path difference between the ordinary light and the extraordinary light caused in the Wollaston prism 50 by the rutile element 210.

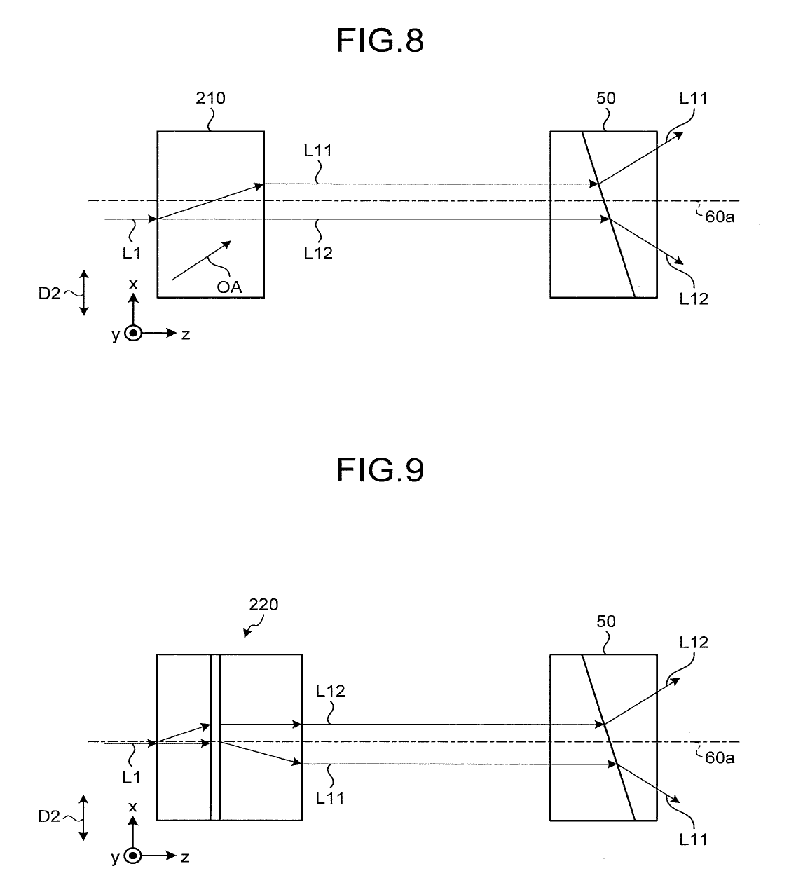

FIG. 8 is an explanatory diagram of a configuration in the optical switch device 3000 according to the third embodiment. The signal light L11 is extraordinary light and the signal light L12 is ordinary light. An optical axis OA of the rutile element 210 is set to have an angle of 47.8 degrees, for example. By setting the thickness of the rutile element 210 in a direction of the optical axis 60a to 12 millimeters and the thickness of the Wollaston prism 50 in the direction of the optical axis 60a to 17.6 millimeters, the PMD caused in the Wollaston prism 50 can be compensated by the rutile element 210.

FIG. 9 is an explanatory diagram of a configuration using a deformed Savart plate. That is, in FIG. 9, the rutile element 210 is replaced by a deformed Savart plate 220 in the configuration of the optical switch device 3000. The deformed Savart plate 220 is a polarization separation element having a structure in which a half wavelength plate is put between two rutile elements. If the deformed Savart plate 220 is used as illustrated in FIG. 9, by appropriately designing the deformed Savart plate 220, the optical path difference between the ordinary light and the extraordinary light can be increased even with the same thickness. As a result, the PMD caused in the Wollaston prism 50 can be compensated by a thinner deformed Savart plate 220.

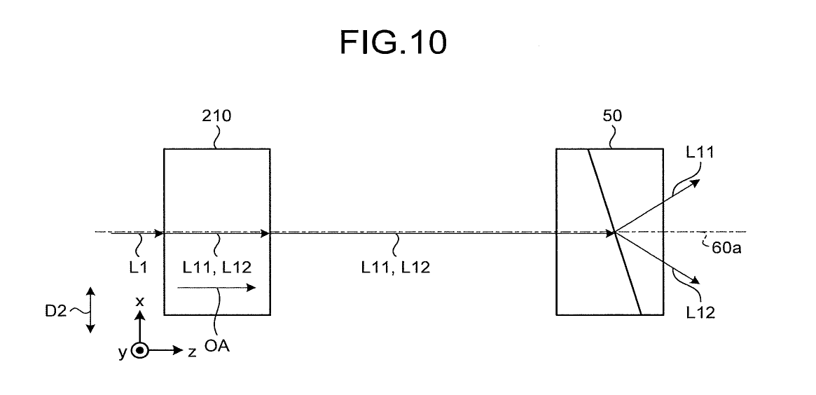

FIG. 10 is an explanatory diagram of a configuration in which the optical axis of the rutile element is changed. In FIG. 10, the rutile element 210 is arranged so that the optical axis OA of the rutile element 210 becomes parallel to the incident direction of the signal light L1 with respect to the rutile element 210. In this case, the signal light L11 as the extraordinary light and the signal light L12 as the ordinary light included in the signal light L1 propagates along the incident direction of the signal light L1 (along the optical axis 60a) without being spatially separated. However, an optical path difference is generated between these signal lights due to a difference in the refractive index. The PMD caused in the Wollaston prism 50 can be compensated by the rutile element 210 also in the configuration illustrated in FIG. 10.

In the configuration illustrated in FIG. 10, the rutile element 210 does not perform spatial polarization separation. Therefore, by adding the rutile element 210 with the optical axis OA being set as in the case of FIG. 10 to the optical switch devices according to the first and second embodiments, the PMD caused in the Wollaston prism 50 can be compensated by the rutile element 210 in the respective optical switch devices.

Furthermore, in the configurations described with reference to FIG. 8 to FIG. 10, the Wollaston prism 50 consists of calcite, and the rutile element is used for compensating the PMD thereof. However, the element that compensates the PMD in the Wollaston prism 50 is not limited to the rutile element, and an element consisting of a birefringent material having a magnitude relation between the refractive index with respect to the ordinary light and the refractive index with respect to the extraordinary light, opposite to that of the birefringent material constituting the Wollaston prism 50, is sufficient to be used.

In the embodiments described above, the Wollaston prism 50 as a polarization operation element is provided. The polarization operation element is not particularly limited so long as an element outputs two lights, which are included in the input light and have a polarization state orthogonal to each other, in a direction forming an angle to each other, and a Rochon prism can be used, for example. Further, the optical operation element is not limited to the LCOS. The present disclosure can be applied to an optical switch device so long as the device includes an optical operation element having polarization dependence characteristics.

In the embodiments described above, the diffraction grating is transmission type. However, the present disclosure is not limited thereto, and a reflective diffraction grating can be used. Other optical dispersion elements such as a dispersion prism can be also used instead of the diffraction grating. If the transmission diffraction grating or the dispersion prism is used, the optical path from the optical input/output port 10 to the diffraction grating (or the dispersion prism) and the Wollaston prism 50 are not likely to spatially interfere with each other, which is preferable.

Furthermore, in the embodiments described above, the optical switch device 1000 is a 1×3 optical switch. However, in the present disclosure, the number of input/output ports, to or from which light is input or output, is not particularly limited, and an N×M optical switch (N and M are arbitrary integers) is sufficient. For example, in the configuration of the optical switch device 1000, the optical switch device 1000 can be operated in such a manner that a signal light is input from any of the optical fiber ports 12, 13, and 14 and the signal light is output from the optical fiber port 11 being the Com port. Accordingly, the optical switch device 1000 can be used as the 3×1 optical switch.

According to the present disclosure, it is possible to realize a wavelength-selecting optical switch device that can decrease a footprint, is inexpensive, and has excellent insertion loss characteristics.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wavelength-selecting optical switch device comprising:
an optical input/output port comprising a plurality of ports, to which light is input from outside or from which light is output to outside, the plurality of ports being arrayed in an optical switch direction;
an optical operation element having polarization dependence characteristics and configured to output light input from any port of the optical input/output port to any port of the optical input/output port;
a condenser lens system arranged between the optical input/output port and the optical operation element and configured to optically couple the optical input/output port with the optical operation element;
an optical dispersion element arranged between the optical input/output port and the condenser lens system and configured to disperse input light in a light dispersion direction;
a polarization operation element arranged between the condenser lens system and the optical dispersion element and configured to output two lights included in input light and having a polarization state orthogonal to each other in a direction forming an angle to each other on a plane parallel to the optical switch direction; and
a polarization rotation element arranged between the polarization operation element and the optical operation element and configured to cause polarization directions of two lights output from the polarization operation element and having a polarization state orthogonal to each other to be identical to each other.

2. The wavelength-selecting optical switch device according to claim 1, wherein the optical operation element is a spatial light modulator.

3. The wavelength-selecting optical switch device according to claim 1, wherein the optical dispersion element is a transmission diffraction grating.

4. The wavelength-selecting optical switch device according to claim 1, wherein the polarization operation element is a Wollaston prism.

5. The wavelength-selecting optical switch device according to claim 1, wherein as a lens having refractive power in the optical switch direction, only the condenser lens system is provided.

6. The wavelength-selecting optical switch device according to claim 5, wherein the condenser lens system is arranged so that the two lights are substantially focused in the spatial optical modulator.

7. The wavelength-selecting optical switch device according to claim 1, wherein the condenser lens system comprises an aspheric lens.

8. The wavelength-selecting optical switch device according to claim 1, wherein the condenser lens system comprises two plano-convex lenses arranged opposite to each other.

9. The wavelength-selecting optical switch device according to claim 1, further comprising a control unit configured to control the optical operation element, wherein
the control unit controls respective regions of the optical operation element, to which the two lights are respectively input, so as to reflect the respective lights at an angle different from each other.

10. The wavelength-selecting optical switch device according to claim 9, wherein the control unit controls the optical operation element so that one of the two lights is attenuated.

11. The wavelength-selecting optical switch device according to claim 9, wherein the control unit controls the respective regions of the optical operation element so as to have characteristics in a form of Fresnel lens having a different shape from each other in the optical switch direction.

12. The wavelength-selecting optical switch device according to claim 1, further comprising a collimator lens provided corresponding to each of the plurality of ports included in the optical input/output port, wherein
a spot size at a beam waist of light input from the optical input/output port immediately after the collimator lens is 60 micrometers or less.

13. The wavelength-selecting optical switch device according to claim 1, wherein an array pitch of the plurality of ports included in the optical input/output port is 250 micrometers or less.

14. The wavelength-selecting optical switch device according to claim 1, wherein the two lights are configured to enter into a surface of the optical operation element vertically.

15. The wavelength-selecting optical switch device according to claim 1, further comprising a polarization separation element arranged on a side of the optical input/output port with respect to the polarization operation element and configured to separate input light into two linearly polarized lights orthogonal to each other, and to output the separated lights so that respective propagation directions of the separated lights become parallel to a propagation direction of the input light.

16. The wavelength-selecting optical switch device according to claim 15, wherein the polarization separation element is formed of a birefringent material having a magnitude relation between a refractive index with respect to ordinary light and a refractive index with respect to extraordinary light, opposite to that of the polarization operation element.

17. The wavelength-selecting optical switch device according to claim 1, wherein
the optical input/output port includes a plurality of port groups, and the port groups are configured so that input/output directions of light to/from ports included in the same port group are parallel to each other, and input/output directions of light to/from ports included in different port groups are different from each other, and
the wavelength-selecting optical switch device is configured to include a plurality of unit optical switch devices respectively including the respective port groups.
